(19) United States
(12) Patent Application Publication
(10) Pub. No.: US 2014/0291938 A1
(43) Pub. Date: Oct. 2, 2014

(54) BELLOWS FOR A GANGWAY BETWEEN TWO HINGE-LINKED VEHICLES, AN AIRCRAFT BOARDING STAIRS, OR AN AIRCRAFT BOARDING BRIDGE

(71) Applicants: Claus-Ekkehard Koukal, Kassel (DE); Reinhard Hübner, Kassel (DE)

(72) Inventors: Claus-Ekkehard Koukal, Kassel (DE); Reinhard Hübner, Kassel (DE)

(73) Assignee: Hübner GmbH & Co. KG, Kassel (DE)

(21) Appl. No.: 14/238,797

(22) PCT Filed: Jul. 4, 2012
(86) PCT No.: PCT/DE2012/000683

§ 371 Date: Apr. 21, 2014

(30) Foreign Application Priority Data
Aug. 17, 2011 (DE) 10 2011 110 873.8

(51) Int. Cl. B60D 5/00

(52) U.S. Cl. CPC B60D 5/003; B60D 5/006
USPC 277/345

(57) ABSTRACT

A bellows for a gangway between two hinge-linked vehicles, an aircraft boarding stairs or an aircraft boarding bridge, has several bellows frames in the longitudinal direction of the bellows. The bellows has an at least single-layered reinforcement, which is coated on at least one side with a plastic material. The reinforcement has guides for the bellows frames. The coated reinforcement is tensioned in the circumferential direction of the bellows at least between two bellows frames.

The invention relates to a bellows of a gangway between two hinge-linked vehicles or to a bellows of aircraft boarding stairs or of an aircraft boarding bridge, the bellows having several bellows frames in the longitudinal direction of the bellows, the bellows comprising an at least single-layered reinforcement that is coated with a plastic material on at least one side, the reinforcement having guides for the bellows frames. In the following, the term “plastic material” also refers to elastomers.

A bellows of the type mentioned in the introduction is known from DE 10 2006 061 503 A1. The object of that citation is a material web for manufacturing a bellows, the material web being coated with a plastic layer, the material web having a textile upper side and a textile bottom side, spacer yarns, so-called pile yarns, being provided between the upper side and the bottom side for forming a so-called spacer fabric. In the space between the textile upper side and bottom side, lanes are provided in the pile yarns connecting the textile upper side and bottom side, which extend in the circumferential direction of the bellows and serve to receive the bellows frames. The bellows frames are hereby circumferentially U-shaped or box-shaped in accordance with the material web, the bellows frames being detachably connectable to each other at least in the area of the floor of the bellows, in order to be able to pull such a bellows over a gangway bridge or a platform, which, in addition to the bellows, is also part of a gangway between two hinge-linked vehicles.

Using such a spacer or pile fabric to manufacture a bellows is advantageous more specifically with regard to a simple and therefore inexpensive production of such a bellows. In addition, such a bellows also insulates against heat and absorbs sound.

Bellows, more specifically when they are mounted as bellows between two hinge-linked vehicles, are subjected to various travel movements. Bellows that are part of a rail vehicle not only experience roll, pitch and bending movements but must also be able to resist forces resulting from a transverse offset of the vehicle parts of a rail vehicle. Moreover, combinations of the previously mentioned movements also occur.

More specifically in articulated buses, great bend angles of up to 54° can be noted, which a bellows connecting the two car bodies of such an articulated bus must be able to follow. In addition, a bus bellows must also be able to follow occurring roll and pitch movements. It has turned out that a bellows with a spacer fabric according to DE 10 2006 061 503 A1 is indeed able to follow the afore-mentioned movement types. However, it has also turned out that the textile upper side and bottom side coated with an elastomer show increased wear. In particular, it has turned out that the elastomer layer peels off from the textile upper side and bottom side. The reason for this is that when the bellows is deformed, the textile material does not bend in a defined manner, more specifically in the corner area. This means that with identical movements the bending of the textile material web forming the bellows is substantially always different. This results in the coating peeling off from the textile upper side and bottom side.

A bellows is known from PCT/DE2007/002211 in which the bellows material is designed as a pile fabric. The pile fabric comprises lanes at fixed intervals to alternately receive bellows frames and ropes. The ropes tie up the bellows between two bellows frames, in order to cause a defined bending of the bellows when it is deformed. However, tying up the bellows results in creases being formed in the corner area. These creases rub against each other. The bellows material consists of a reinforcement coated with an elastomer. This elastomer coating peels off when the creases rub against each other. In this respect, the bellows is irreversibly damaged after a short time and must be replaced.

Therefore, the problem underlying the invention consists in providing a bellows of a gangway of the type mentioned in the introduction that is submitted to less wear.

In order to solve the problem, the invention proposes that the coated reinforcement is under tensile stress in the circumferential direction of the bellows at least between two bellows frames. If the material of the bellows, i.e. the coated more specifically single-layer reinforcement, which can be designed as a woven fabric, as a weft-knitted fabric or as a warp-knitted fabric, is tensioned between the bellows frames in the circumferential direction of the bellows, this results in a wave shape of the bellows without bends or folds forming in the corner area. The wave shape is all the more pronounced the greater the tensile stress that is applied on the reinforcement between two bellows frames. It has turned out that if the at least single-layered reinforcement is sufficiently tensioned, the bellows, when deformed, is always deformed in the same manner, which means that a defined folding of the at least single-layered reinforcement is achieved, more specifically in the corner area. It has turned out that with such a pretension of the reinforcement wear caused by peeling of the plastic layer can be substantially reduced.

In order to produce such a pretension, it is provided in particular, according to a first variant that the two ends of the reinforcement coated with a plastic material comprise grommets, which serve to receive tensioning means, for example tensioning ropes, turnbuckles or the like, in order to apply the corresponding pretension onto the coated reinforcement that forms the material web for the bellows.

A second variant is characterized in that the two ends of the reinforcements coated with a plastic material are connected to each other by a strap under tensile load. The strap can have a width that corresponds approximately to the width of the bellows. This shows that the strap is designed in the manner of a floor cloth. The floor cloth can be connected at both ends to the coated reinforcement of the bellows by way of hook-and-loop tapes, wherein it is also possible to permanently connect, i.e. glue the strap on one side of the reinforcement and to form a connection by means of a hook-and-loop tape (Velcro-tape) with the coated reinforcement of the bellows. The material of the strap preferably corresponds to that of the coated reinforcement of the bellows.

Advantageous features of the invention can be gathered from the dependent claims.

Thus, it is more specifically provided that in order to form the guides for the bellows frames, the reinforcements comprises at least an additional layer of reinforcement. There are several possibilities for forming the afore-mentioned guides for the bellows frames. On the one hand, it is possible to form guides in form of loops by doubling an additional layer of reinforcement. The connection between the layers of the reinforcement can be implemented by sewing, weft-knitting, warp-knitting or for example by gluing. It is only important to form a free space in form of a sleeve-shaped guide, which serves to receive the respective bellows frame with a certain clearance. However, it is also conceivable to superimpose another at least single-layered reinforcement on the at least single-layered reinforcement, namely over the entire surface of the one first reinforcement, the second reinforcement however having sleeve-shaped circumferential hollow spaces at fixed intervals relative to the first reinforcement for receiving the bellows frames. The connection of the first reinforcement to the second reinforcement can be implemented by sewing by means of threads or yarns or by gluing or welding.

According to another feature of the invention, it is provided that the bellows frames are slidingly received in the guides or loops. It has already been mentioned in the introduction, that such a bellows is submitted to various types of movements. It has turned out that the wear of the bellows as such can be substantially reduced by allowing the bellows frame to move inside the guides. This means that the bellows frames perform a relative movement relative to the reinforcements surrounding them. This relative movement must be impeded as little as possible, which is why it is more specifically also provided that the bellows frames or the guides themselves are coated with a lubricant, e.g. a PTFE. The bellows frames are advantageously slidingly guided in a PTFE sleeve.

It has already been pointed out that a woven fabric, a weft-knitted fabric or a warp-knitted fabric can be used as reinforcement. Weft-knitted and warp-knitted fabrics being knitted fabrics, they are elastic as such. This means that after having been coated with a plastic material, for making such a bellows fabric impermeable to water, a reinforcement made of a weft-knitted or warp-knitted fabric forms a textile fabric that is highly elastic in both spatial directions. A woven fabric can also be designed to be elastically resilient in one spatial direction if such a woven fabric has elastic threads, yarns or ribbons. If the warp threads and the weft threads or the ribbons of a woven fabric are designed to be elastically resilient, a so-called bidirectionally elastic woven fabric is provided. Such woven fabrics are also outstandingly adapted for manufacturing reinforcements in form of woven fabrics for the previously described applications. However, it is also conceivable to use such elastic threads for a warp-knitted or weft-knitted fabric. Such elastic threads, yarns or ribbons can be made of a reticulated elastomer, e.g. a silicone elastomer or an organic elastomer. Organic elastomers more specifically include CSM, EPDM, AEM, etc. The coating of the reinforcement can also be implemented with various plastic materials in accordance with requirements. For example the coating can be based on a silicone rubber or an organic rubber, e.g. a CSM, CM, EVA, EPDM, AEM or PVC.

It has already been pointed out that the requirements for a bellows for road traffic and rail traffic are quite different. In rail traffic, bellows are frequently submitted to a transverse offset, which occurs when such a rail vehicle drives for example over an S-shaped railroad switch. Articulated buses must be able to drive around a so-called unit circle, which implies that they must drive around bend radiuses of up to 54°. This leads to extreme compression of the bellows on the inner side of the bend, whereas an extreme extension of the bellows takes place on the outer side of the bend. This means that all the folds or waves forming the bellows are used on the outer side of the bend in order to provide the required extension length. More specifically in road use, for example in an articulated bus, it has turned out that the bellows according to the invention is submitted to less wear if the bellows frames consecutively disposed in a spaced-apart relationship in the longitudinal direction of the bellows have a different circumference, i.e. more specifically if in the assembled state of the bellows the horizontal webs of the bellows frames are configured shorter than those of the respectively adjacent bellows frame. This means that in the assembled state of such a bellows the bellows frames have the same height, but every other bellows frame, when assembled, has a smaller horizontal extension, i.e. a smaller width than the respectively adjacent bellows frame.

It has already been pointed out that when driving around a bend, the bellows must provide a considerable extension length on the outer side of the bend while being submitted on the inner side of the bend to a considerable bending. Due to the different sizes of the bellows frames with regard to their horizontal extension in the assembled state, when driving around a bend, the respectively circumferentially smaller bellows frame moves in its guide toward the outer side of the bend, a material reserve being hereby displaced toward the outer side of the bend because of this horizontal displacement toward the outer side of the bend, thus helping to provide the required extension length. This means that the narrower the bend that one must drive through, the further outward the smaller bellows frame in the circumferential direction moves in the guide and in this manner ensures that the required extension length is provided on the side of the vehicle located on the outer side of the bend. On the inner side enough material is provided so that the bellows frame is not impeded in its movement toward the outer side of the bend. The guide, e.g. in form of a loop, receives the bellows frame made of metal or a composite material with a clearance, the bellows frame being provided with a sliding layer if necessary, e.g. is mounted in a PTFE-tube.

In the following the invention is exemplarily described in more detail based on the drawings.

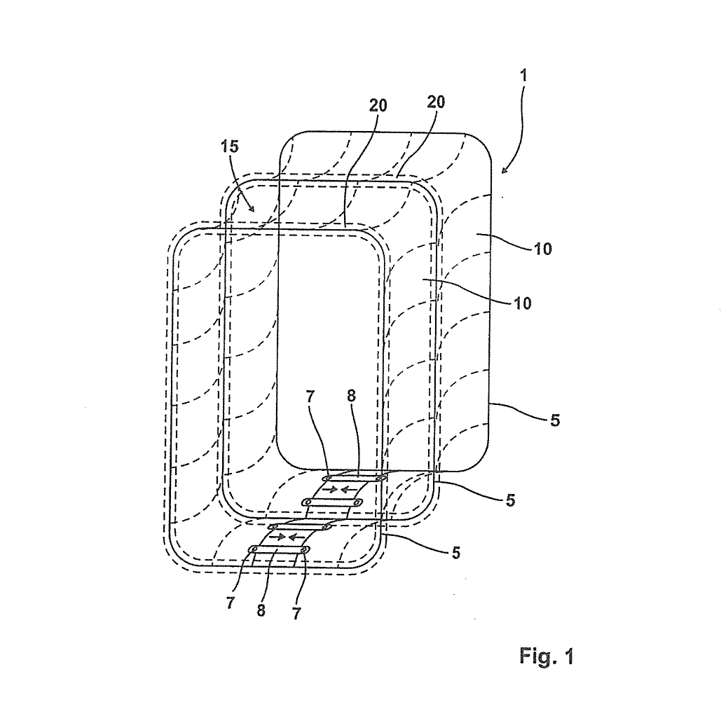

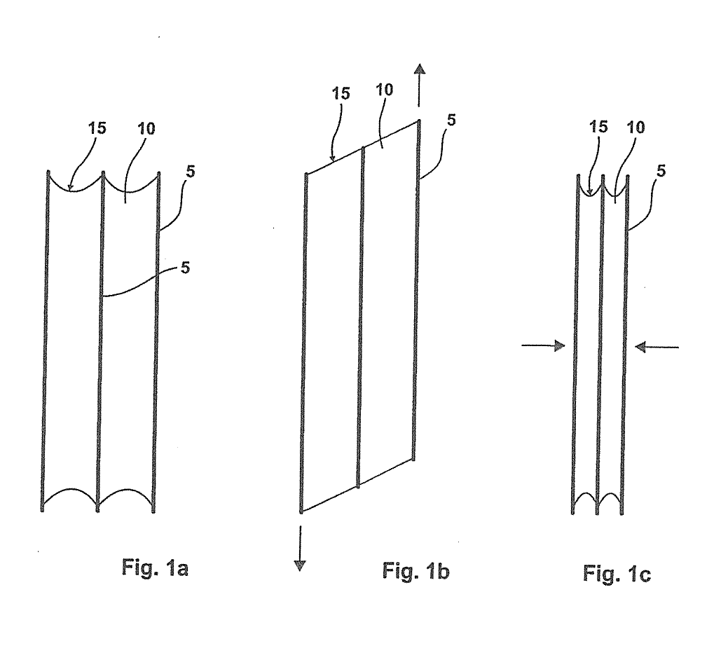

FIG. 1 schematically shows a bellows with bellows frames having the same size with regard to the circumference of the bellows

FIG. 1a shows a bellows according to FIG. 1 in a neutral position in a top view;

FIG. 1b shows a bellows according to FIG. 1 in a transverse offset in a top view;

FIG. 1c shows a bellows according to FIG. 1 in case of bending in a top view;

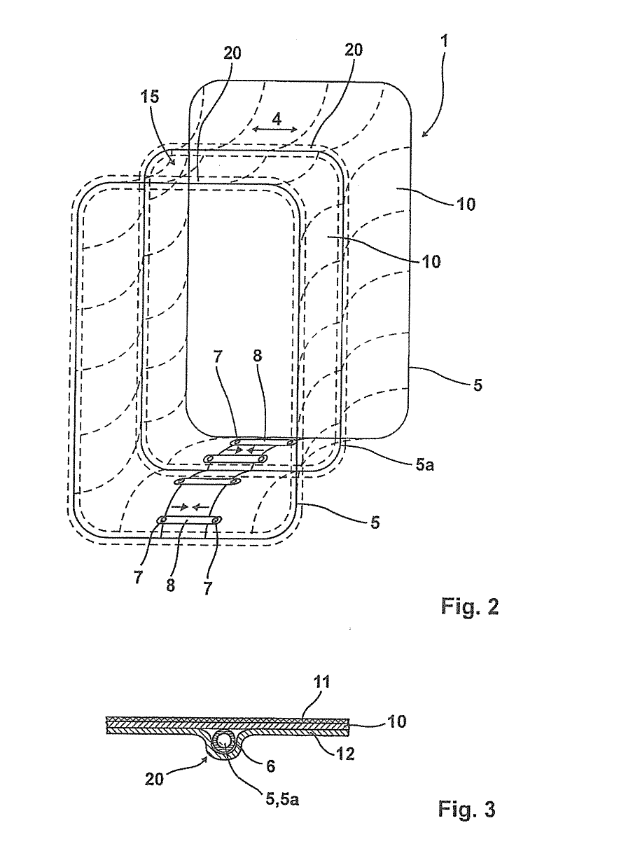

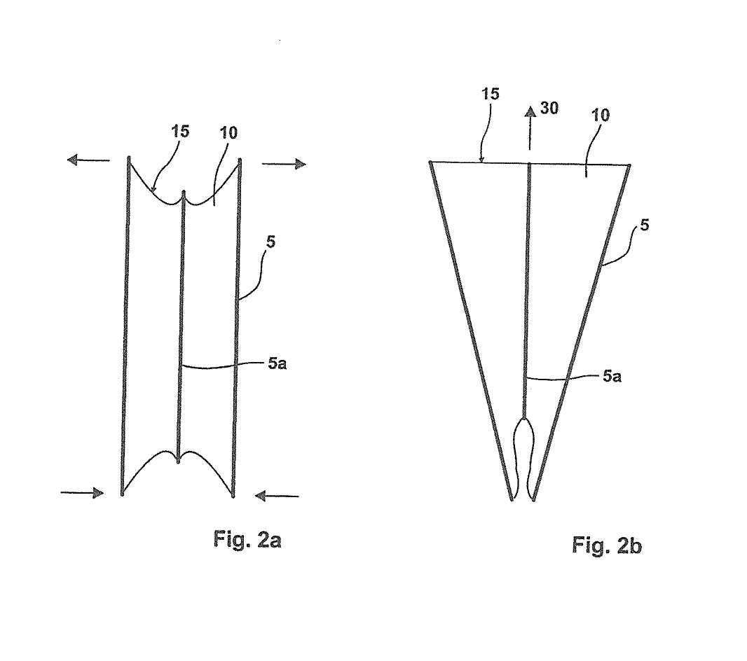

FIG. 2 shows a bellows, every other bellows frame having a lesser width in the circumferential direction;

FIG. 2a shows such a bellows according to FIG. 2 in a neutral position in a top view;

FIG. 2b shows a bellows according to FIG. 2 in a bent position (when traveling around a bend) in a top view;

FIG. 3 schematically shows a section through a single-layered reinforcement with a second reinforcement disposed on it with formation of a loop for receiving a bellows frame in the guide designed as a loop.

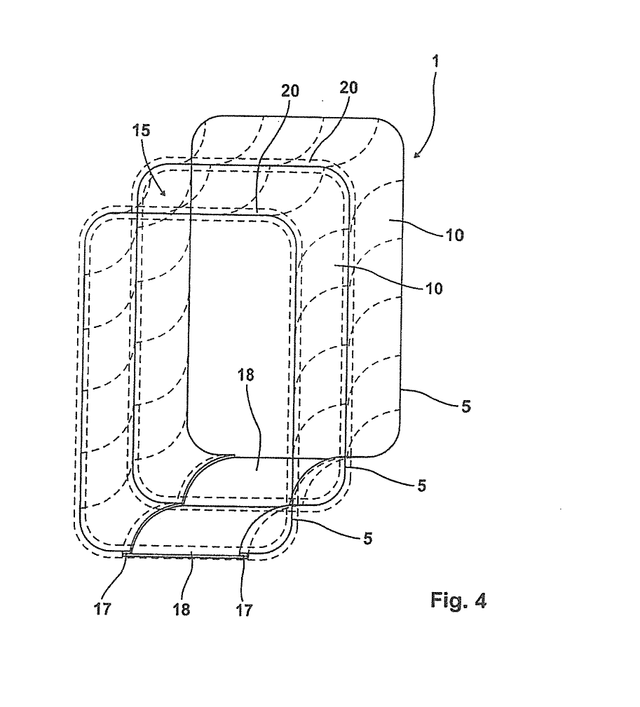

FIG. 4 shows a representation according to FIG. 1, a strap being however provided for connecting the ends of the bellows.

The representations shown in the figures are mere schematics. The bellows labeled 1 shown in FIG. 1 comprises several consecutively disposed bellows frames 5, wherein, in order to form the bellows, the bellows frames comprising the reinforcement 10 coated on at least one side with a plastic material. The reinforcement 10 is designed as a material web which includes respective guides 20, which will be dealt with later on, for receiving the several consecutively disposed bellows frames 5. The bellows shown in FIG. 1 comprises bellows frames 5, which are designed to have the same size with regard to their circumference. It can be seen that the reinforcement 10 designed as a material web has a distinct wave shape (arrow 15) between the bellows frames 5. The wave shape is formed by the material web formed by a reinforcement coated with a plastic material having grommets 7 facing each other in the area of the open end of the material web in the floor area of the bellows, which are connected to each other by a tensioning means 8. The tensioning means 8, for example a turnbuckle or a rope ensures that when applying a corresponding tension, the reinforcement coated with a layer of plastic material takes the previously mentioned wave shape between the bellows frames 5. This can also be seen in FIG. 1.

The embodiment according to FIG. 4 differs from that of FIG. 1 in that the ends of the reinforcement of the bellows are connected to each other under a tensile stress in the floor area by a strap 18. The strap 18 has a width that corresponds to that of a floor cloth. This means that when such a floor cloth is worn out it can be replaced. However, this also means that if the floor cloth has a corresponding width, the wear of the bellows in the floor area and here more specifically of the coated reinforcement can be minimized. Hook or loop straps, which run along the bellows, are provided on both sides for fastening the strap 18. The strap preferably consists of the same material as the coated reinforcement of the bellows. The fastening can not only take place by way of hook-and-loop straps (Velcro straps) but for example also by gluing or with a combination of gluing and hook-and-loop straps.

A bellows constructed in this manner is more specifically adapted for use in rail vehicles. Indeed rail vehicles travel only around bends with small radiuses but to some extent experience a considerable transverse offset when traveling over S-shaped railroad switches. A bellows such as shown in figure lb is indeed well adapted to follow such a transverse offset. This means that the bellows is displaced in the transverse direction. FIG. 1 a shows the neutral position of the bellows and FIG. 1c shows the bent position of the bellows.

The representation according to FIG. 2 differs from that of FIG. 1 in that bellows frames 5, 5a of different widths are used there. A bellows frame 5 is followed by a bellows frame 5a, the lateral extension of which is smaller in the direction of the arrow 4, i.e. its width is smaller than that of the adjacent bellows frame 5. However, here too, a distinct wave shape of the material web formed by the coated reinforcement 10 and receiving the individual bellows frames 5, 5a can be found. Just like the bellows according to FIG. 1, the reinforcement 10 forming the material web comprises grommets 7 in the area of its open end on both sides, which are connected to each other by tensioning means 8, e.g. by a turnbuckle or a rope, in order to tension the reinforcement in the circumferential direction, thus resulting in the previously mentioned wave shape—marked by the arrow 15 in the representation according to FIG. 2. In this context, if one looks at FIGS. 2a, 2b, one can see the deformation of such a bellows when driving around a bend. FIG. 2 shows the initial position, i.e. the neutral position of the bellows, whereas FIG. 2b shows the bellows when driving around the bend. It can be seen in FIG. 2b that the bellows frame 5a having the smaller frame width moves toward the outer side of the bend in the direction of the arrow 30 and thereby provides a material reserve there, which makes it possible to provide the required extension length on the outer side of the bend. On the inner side of the bend, the bellows is bent thus creating the material reserve that ultimately at least partially provides for the required extension on the outer side of the bend by way of the displacement of the bellows frame 5a toward the outer side of the bend. However, when the material of the bellows, i.e. the coated reinforcement, has an elastic configuration not only in the circumferential direction but also in the longitudinal direction of the bellows, i.e. parallel to the longitudinal axis of the vehicle, a certain extension can be provided by the material of the bellows when driving around a bend, which means that material can be saved. The coated reinforcement is then bidirectionally elastic.

FIG. 3 shows the arrangement of the bellows frames on the reinforcement 10 provided with a plastic layer 11. In this context, the reinforcement 10 comprises another reinforcement 12, wherein the reinforcement 12 can also be designed as a woven fabric, a warp-knitted fabric or a weft-knitted fabric. This reinforcement 12 can also be provided with a plastic layer on its outer side, for example with an organic elastomer. The reinforcement 12 is connected to the reinforcement 10, either by sewing, weft-knitting, warp-knitting, welding or gluing. The connection of the reinforcement 12 to the reinforcement 10 takes place with formation of guides 20 in form of loops for receiving the respective bellows frame 5, 5a. In order to form the wave shape, both reinforcements 10, 12 are ultimately tensioned between the bellows frames 5, 5a, more specifically when e.g. two reinforcements are connected to each other across their entire surface except for the guides. In order to ensure the sliding movement of the bellow frame 5a, more specifically, in the guide 20, which is configured in the manner of a loop, the bellows frame 5a is advantageously mounted in a tube 6 made of a sliding material, e.g. a PTFE. This does not exclude displaceably mounting the bellows 5. To this end, the bellows frame 5, 5a is more specifically mounted with a clearance in the respective guide 20.

### LIST OF REFERENCE NUMBERS

1 Bellows
4 Arrow
5 Bellows frame
5a Bellows frame
6 Tube
7 Grommet
8 Tensioning means
10 Reinforcement
12 Reinforcement
15 Arrow
17 Hook-and-loop strap
18 Strap (floor cloth)
20 Guide (loop)
30 Arrow

1-16. (canceled)

17. A bellows for a gangway between two hinge-linked vehicles, an aircraft boarding stairs or an aircraft boarding bridge, the bellows comprising:
a plurality of bellows frames disposed in a longitudinal direction of the bellows; and
an at least single-layered reinforcement coated on at least one side with a plastic material, the reinforcement having guides for slidably receiving the bellows frames;
wherein the coated reinforcement is pre-tensioned in a circumferential direction of the bellows at least between two of the bellows frames in order to create a tensile stress.

18. A bellows in accordance with claim 16, wherein the reinforcement is a woven fabric, a weft-knitted fabric or a warp-knitted fabric.

19. A bellows in accordance with claim 16, wherein the reinforcement comprises a first layer of reinforcement and further comprises a a second layer of reinforcement at least in the area of the guides for forming the guides for the bellows frames.

20. A bellows in accordance with claim 18, wherein the first and second layer of reinforcement are connected to each other by sewing, weft-knitting, warp-knitting, gluing or welding.

21. A bellows in accordance with claim 16, wherein the bellows frames are received in the guides with a clearance.

22. A bellows in accordance with claim 16, wherein the reinforcement has elasticity at least in the circumferential direction of the bellows.

23. A bellows in accordance with claim 16, wherein the reinforcement comprises elastic threads, yams, ribbons or fibers.

24. A bellows in accordance with claim 16, wherein the bellows frames consecutively disposed in the longitudinal direction of the bellows respectively alternatively have a different horizontal widths.

25. A bellows in accordance with claim 16, wherein the coating of the reinforcement is a silicone rubber or an organic rubber.

26. A bellows in accordance with claim 16, wherein the bellows frame and/or the guides are provided with a coating.

27. A bellows in accordance with claim 25, wherein the coating is PTFE.

28. A bellows in accordance with claim 16, wherein the bellows frames are mounted in a tube made of a sliding material.

29. A bellows in accordance with claim 27, wherein the sliding material is PTFE.

30. A bellows in accordance with claim 16, wherein the reinforcement is elastically resilient in two spatial directions.

31. A bellows in accordance with claim 16, further comprising a a strap connecting ends of the coated reinforcement of the bellows, the strap applying the pre-tensioning to the reinforcement.

32. A bellows in accordance with claim 30, wherein the strap is connected to the coated reinforcement of the bellows by way of hook-and-loop straps.

33. A bellows in accordance with claim 30, wherein the strap extends along a substantial part of the width of the bellows.
